(19) United States
(12) Patent Application Publication
(10) Pub. No.: US 2005/0081982 A1
(43) Pub. Date: Apr. 21, 2005

(54) Method for making a ball

(76) Inventor: Szu-Jen Chen, Samuisakron (TH)

Correspondence Address: Cooper & Dunham LLP, 1185 Avenue of the Americas, New York, NY, 10036, US

(21) Appl. No.: 10/687,101

(22) Filed: Oct. 16, 2003

(51) Int. Cl. B32B 31/00

(52) U.S. Cl. 156/228; 156/245; 156/287; 264/511; 264/512

(57) ABSTRACT

A method for making a ball includes the steps of preparing a mold composed of a lower mold and an upper mold detachably connected to the lower mold, wherein the lower mold and the upper mold have multiple suction holes, filling the lower mold and the upper mold with covering pieces, filling the lower mold and the upper mold with strips, placing a bladder in the lower mold and on top of the covering pieces and strips in the lower mold, mating the upper mold with the lower mold, securing the covering pieces on the bladder, and removing finished product from the mold.

### BACKGROUND OF THE INVENTION

1. Field of the Invention

The present invention relates to a ball making method, and more particularly to a method in which labor effort is substantially eliminated and occupational hazard is greatly reduced.

2. Description of Related Art

A conventional method for making a ball includes the steps of preparing a bladder, inflating the bladder, wiring the inflated bladder, patching pieces of a covering on the wired bladder and securing the covering pieces on the wired bladder. Normally, after the bladder made of rubber is inflated, a lining made of wires is wound around the inflated bladder. Then, a covering composed of multiple pieces is patched onto the wired bladder. Finally, the wired ball with patched covering pieces is sent to a mold to secure the bonding between the covering pieces and the wired bladder. After the aforementioned process, the general overall appearance of a ball is finished. During the entire process, a lot of manual work is involved, which inevitably increases the cost. Furthermore, because the process involves the application of adhesives such as methylbenzene to securely attach the covering pieces to the bladder, workers' health is seriously affected and thus risks of introducing occupational hazards is high.

To overcome the shortcomings, the present invention tends to provide an improved ball manufacture method to mitigate the aforementioned problems.

### SUMMARY OF THE INVENTION

The primary objective of the present invention is to provide an improved method for making a ball in which manual effort is substantially eliminated and workers' health is protected through reduction of exposure to harmful chemicals.

Other objects, advantages and novel features of the invention will become more apparent from the following detailed description when taken in conjunction with the accompanying drawings.

### BRIEF DESCRIPTION OF THE DRAWINGS

FIG. 1A is a bottom plan view of a lower mold used in the method of the present invention;

FIG. 1B is a side plan view of an upper mold used in the method of the present invention;

FIG. 2 is an exploded view showing that covering pieces are respectively placed in the lower and upper molds;

FIG. 3 is an exploded view from a bottom angle of the lower mold and the upper mold showing that strips are respectively filed into the lower and the upper mold;

FIG. 4 is a schematic view showing that an automation machine is used in combination with the lower mold and the upper mold, wherein a bladder is placed in the lower mold;

FIG. 5 is a schematic view showing that the upper mold is raised to be ready to mate with the lower mold;

FIG. 6 is a schematic view showing that due to the vacuum suction in the upper mold, the covering pieces and the strips in the upper mold will not fall off when the upper mold is lifted and slanted;

FIG. 7 is a schematic view showing that the upper mold is rotated to be ready to mate with the lower mold; and

FIG. 8 is a schematic view to show the combination of the lower mold and the upper mold.

### DETAILED DESCRIPTION OF THE PREFERRED EMBODIMENT

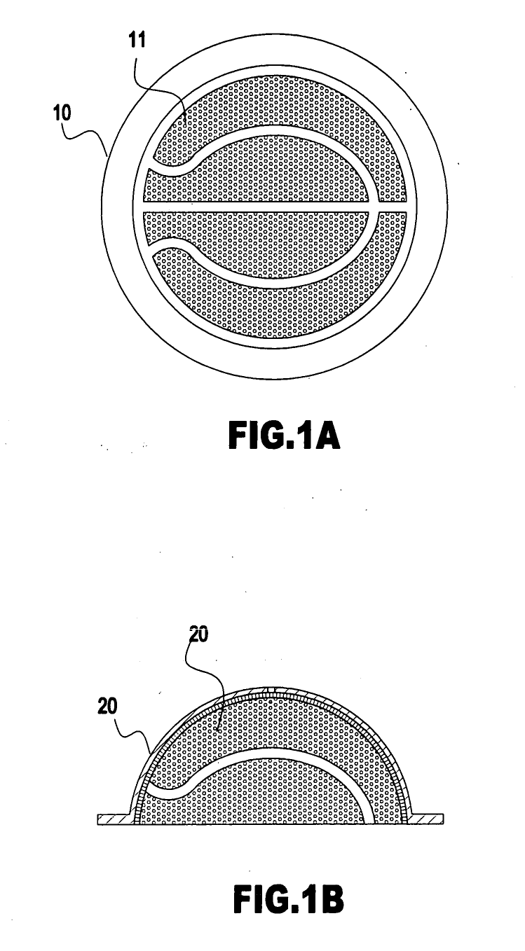

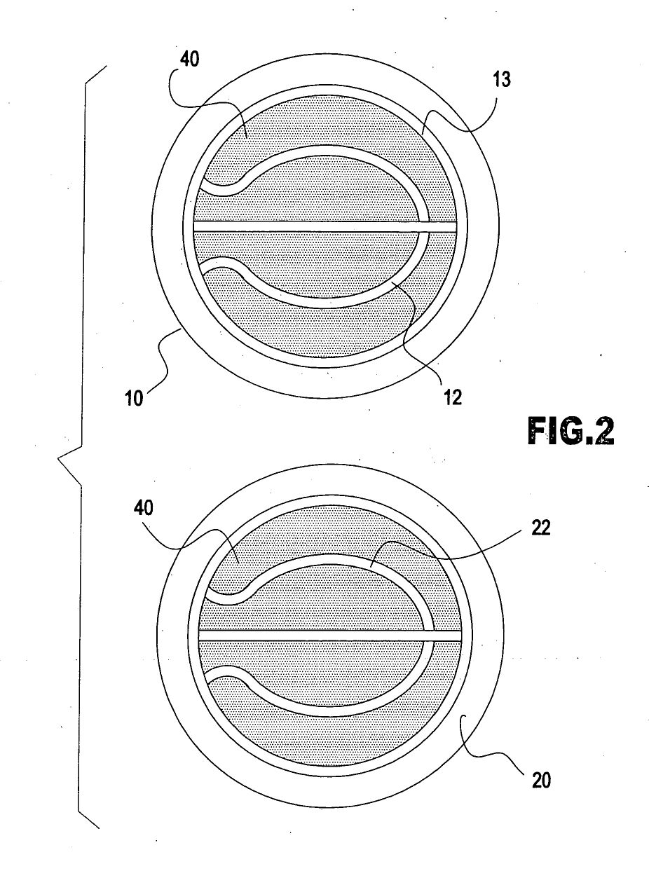

With reference to FIGS. 1A and 1B, the method for making a ball in accordance with the present invention includes the steps of:
1. preparing a mold composed of a lower mold (10) and an upper mold (20) detachably connected to the lower mold (10), wherein both the lower mold (10) and the upper mold (20) have multiple suction holes (11,21);
2. filling the lower mold (10) and the upper mold (20) with covering pieces (40);
3. filling the lower mold and the upper mold with strips (41);
4. placing a bladder (30) in the lower mold (10) and on top of the covering pieces (40) and strips (41) in the lower mold (10);
5. mating the upper mold (20) with the lower mold (10);
6. securing the covering pieces (40) on the bladder (30); and
7. removing finished product from the mold.

It is noted that the suction holes (11,21) in the lower mold (10) and the upper mold (20) are evenly distributed in an inner face of the respective lower mold (10) and the upper mold (20).

With reference to FIG. 2, the inner face of the lower mold (10) and the upper mold (20) is further divided into several portions each corresponding to an area and shape of one covering piece (40). Therefore, when the covering pieces (40) with four layers of adhesive coated thereon are inserted into the lower mold (10) and the upper mold (20), each of the covering pieces (40) corresponds to one of the portions respectively in the lower mold (10) and the upper mold (20). Each of the lower mold (10) and the upper mold (20) has gaps (12,22) defined between two adjacent portions. A circular recess (13,23) is also defined in the inner face of the lower mold (10) and the upper mold (20) to communicate with the gaps (12,22). Thus, each portion in the lower and upper mold (10,20) is isolated from each other by the gaps (12,22).

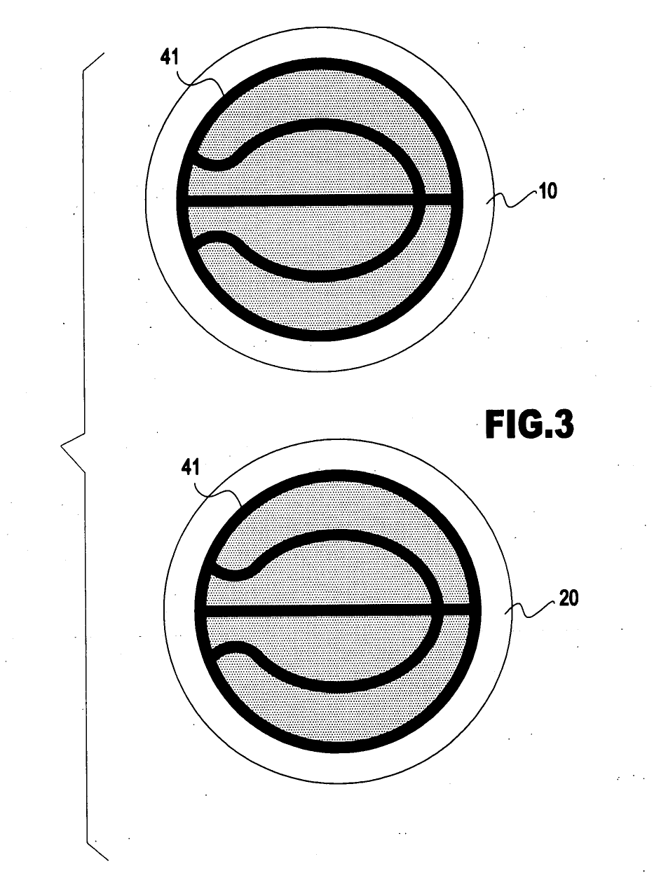

With reference to FIG. 3, thereafter, strips (41) are inserted into the gaps (12,22) and the circular recess (13,23).

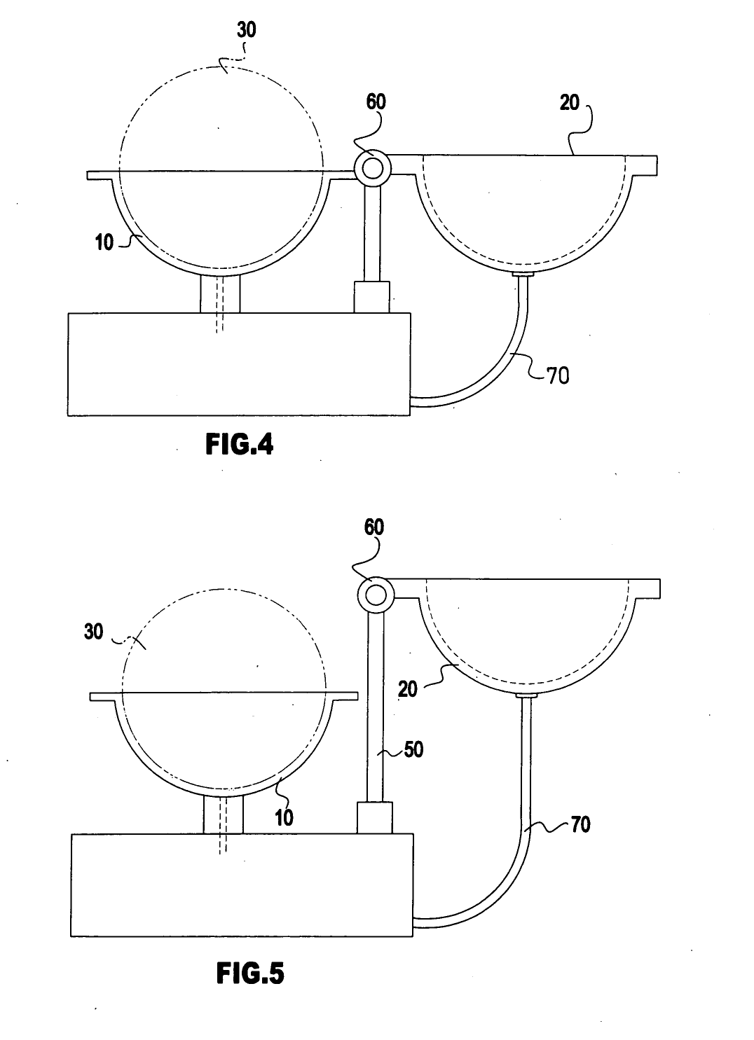

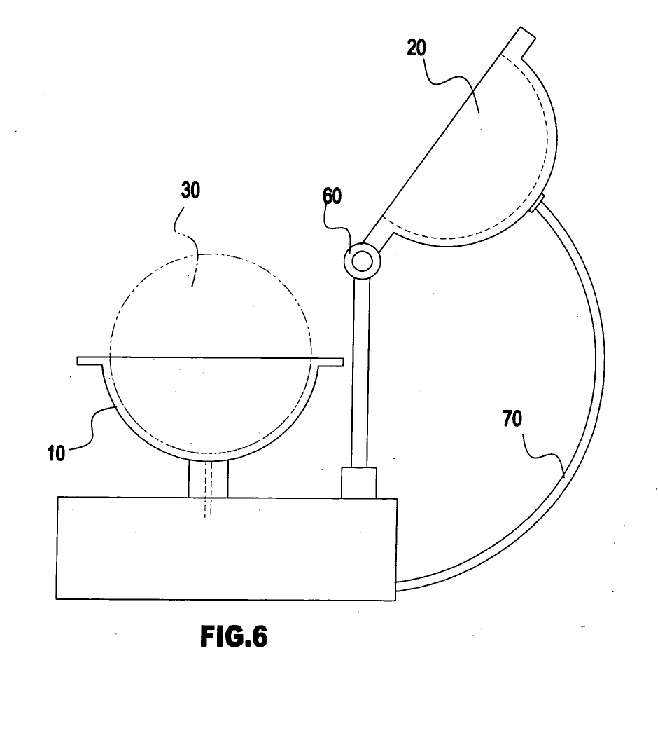

After the covering pieces (40) and strips (41) are fitted into the lower mold (10) and the upper mold (20) respectively, the bladder (30) with two layers of adhesive coated thereon is received in the mold (10) and on top of the covering pieces (40) and the strips (41), as shown in FIG. 4. Then, as shown in FIGS. 5 and 6, an escalating device (50) is provided to lift the upper mold (20). The upper mold (20) is rotated via a rotator (60) mounted on top of the escalating device (50) to overturn the upper mold (20) to mate with the lower mold (10). Before the upper mold (20) is overturned, a vacuum device (70) is provided to suck out the air between the covering pieces (40) and the inner face of the upper mold (20) to create a quasi-vacuum environment such that the covering pieces (40) and the strips (41) in the upper mold (20) will not fall off the upper mold (20) even after the upper mold (20) is overturned.

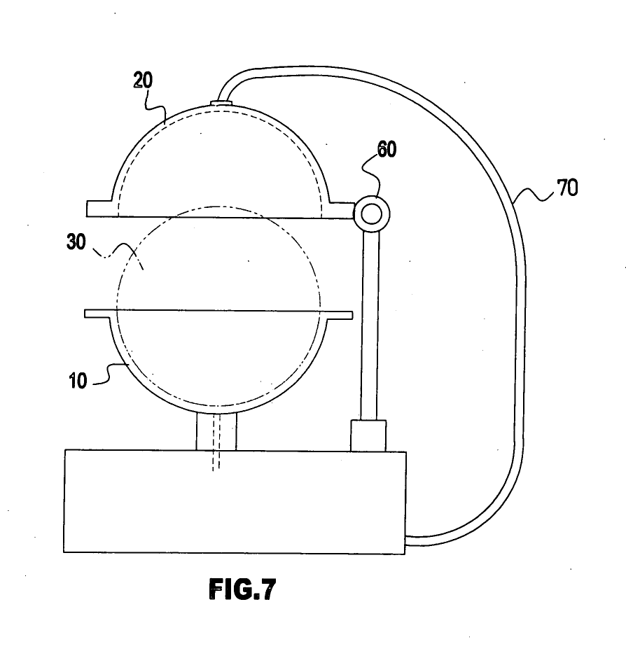

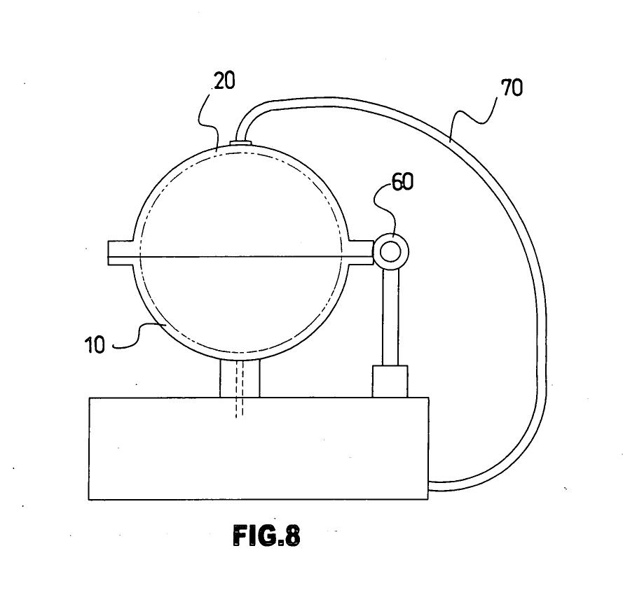

With reference to FIGS. 7 and 8, after the upper mold (20) is overturned, the escalating device (60) is lowered to gradually connect the upper mold (20) to the lower mold (10).

It is noted that when the adhesive is applied on the covering pieces (40) and the bladder (30), the covering pieces (40) and the bladder (30) are then heated to dry the adhesive on the covering pieces (40) and the bladder (30). However, after the upper mold (20) is connected to the lower mold (10), a pressurized process is employed to securely connect the covering pieces (40) and strips (41) to an outer periphery of the bladder (30). After the pressurizing process, the finished product is removed from the mold and is ready for dispatch to a retailer.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A method for making a ball comprising the steps of:
a. preparing a mold composed of a lower mold and an upper mold detachably connected to the lower mold, wherein the lower mold and the upper mold have multiple suction holes;
b. filling the lower mold and the upper mold with covering pieces;
c. filling the lower mold and the upper mold with strips;
d. placing a bladder in the lower mold and on top of the covering pieces and strips in the lower mold;
e. mating the upper mold with the lower mold;
f. securing the covering pieces on the bladder; and
g. removing the finished product from the mold.

2. The method as claimed in claim 1, wherein an inner face the lower mold and upper mold is evenly divided into portions each corresponding to one of the covering pieces and a gap is defined between every two adjacent portions to receive therein a corresponding one of the strips.

3. The method as claimed in claim 2, wherein a circular recess is defined in the inner face of the lower mold and the upper mold to receive therein one of the strips.

4. The method as claimed in claim 1, wherein pressure is employed in the step f to secure the covering pieces on the bladder.

5. The method as claimed in claim 2, wherein pressure is employed in the step f to secure the covering pieces on the bladder.

6. The method as claimed in claim 3, wherein pressure is employed in the step f to secure the covering pieces on the bladder.
